(19) United States
(12) Patent Application Publication
(10) Pub. No.: US 2026/0057007 A1
(43) Pub. Date: Feb. 26, 2026

(54) METHOD, APPARATUS, DEVICE, MEDIUM AND PROGRAM PRODUCT FOR SEARCHING INFORMATION

(71) Applicant: Beijing Zitiao Network Technology Co., Ltd., Beijing (CN)

(72) Inventors: Yuheng Lu, Beijing (CN); Ming Zeng, Beijing (CN); Xin Chen, Beijing (CN); Xinzhu Jia, Beijing (CN); Mingyang Yue, Beijing (CN); Situ Feng, Beijing (CN)

(21) Appl. No.: 19/310,749

(22) Filed: Aug. 26, 2025

(30) Foreign Application Priority Data
Aug. 26, 2024 (WO) PCT/CN2024/114641

(51) Int. Cl. G06F 16/435; G06F 16/438

(52) U.S. Cl. CPC G06F 16/435; G06F 16/438

(57) ABSTRACT

Embodiments of the present disclosure relate to a method, an apparatus, a device, a medium and a program product for searching information. The method comprises in response to determining that request content in a search request from a client is associated with a predetermined category, obtaining a result identifier of an answer result for the search request, and generating, by a machine learning model, content of the answer result for the request content. The method further comprises sending a first response comprising the part of content to the client to display the part of content of the answer result, and in response to receiving from a client an obtaining request, obtaining the remaining part of content generated by the machine learning model, and sending a second response comprising the remaining part of content to the client for displaying the answer result.

### CROSS-REFERENCE TO RELATED APPLICATION(S)

This application claims priority to International Patent Application No. PCT/CN2024/114641, filed Aug. 26, 2024, entitled “METHOD, APPARATUS, DEVICE, MEDIUM AND PROGRAM PRODUCT FOR SEARCHING INFORMATION”, the contents of which are hereby incorporated by reference in their entirety.

### FIELD

Embodiments of the present disclosure generally relate to the field of information search, and more specifically, to method, apparatus, device, medium and program product for searching information.

### BACKGROUND

At present, in case of information searching, returned contents usually are obtained from searching in a database. For example, if a user intends to query information, he or she may use a computing device to send a query request to a server running a search engine. Then, the search engine may search in the database to return corresponding information to a client. Accordingly, the users may obtain various desired information via different search engines.

Besides, search algorithms are constantly improving with advances of information search technology. Accordingly, the search engine can more accurately understand intentions of users, to filter out results in best fit with the users' demands from massive data. Search answers with high precision are thus provided to the users, which greatly satisfy the needs of the users with respect to accuracy and timeliness in information acquisition. Hence, when searching related contents, the users may find the accurate information desired within a short period of time.

### SUMMARY

Embodiments of the present disclosure provide a method, an apparatus, a device, a medium and a program product for searching information.

In accordance with a first aspect of the present disclosure, there is provided a method for searching information. The method comprises in response to determining that request content in a search request from a client is associated with a predetermined category, obtaining a result identifier of an answer result for the search request. The method also comprises generating, by a machine learning model, content of the answer result for the request content. The method further comprises in response to obtaining a part of content of the answer result based on the result identifier, sending a first response including the part of content to the client to display the part of content of the answer result. The method also comprises in response to receiving from a client an obtaining request for obtaining a remaining part of content of the answer result, obtaining the remaining part of content generated by the machine learning model. The method further comprises in response to obtaining the remaining part of content, sending a second response comprising the remaining part of content to the client for displaying the answer result comprising the part of content and the remaining part of content.

In accordance with a second aspect of the present disclosure, there is provided a method for searching information. The method comprises sending a search request to a server, the search request comprising search content. The method also comprises in response to receiving a first response for an answer result of the search content from the server, displaying content of the answer result, wherein the answer result is generated by a machine learning model on the basis of a determination that the search content is associated with a predetermined category. The method further comprises in response to determining that the content of the answer result is a part of content of the answer result, sending to the server an obtaining request for obtaining a remaining part of content of the answer result. The method also comprises in response to receiving a second response comprising the remaining part of content of the answer result from the server, displaying the answer result comprising the part of content and the remaining part of content.

In accordance with a third aspect of the present disclosure, there is provided an apparatus for searching information. The apparatus comprises a result identifier obtaining module configured to, in response to determining that request content in a search request from a client is associated with a predetermined category, obtain a result identifier of an answer result for the search request; a content generating module configured to generate, by a machine learning model, content of the answer result for the request content; a part of content display module configured to, in response to obtaining a part of content of the answer result based on the result identifier, send a first response comprising the part of content to the client to display the part of content of the answer result; a remaining part of content obtaining module configured to, in response to receiving from a client an obtaining request for obtaining a remaining part of content of the answer result, obtain the remaining part of content generated by the machine learning model; and a remaining part of content sending module configured to, in response to obtaining the remaining part of content, send a second response comprising the remaining part of content to the client for displaying the answer result comprising the part of content and the remaining part of content.

In accordance with a fourth aspect of the present disclosure, there is provided an apparatus for searching information. The apparatus comprises a search request sending module configured to send to a server a search request, the search request comprising a search content; a first content displaying module configured to, in response to receiving a first response for an answer result of the search content from the server, display content of the answer result, wherein the answer result is generated by a machine learning model on the basis of a determination that the search content is associated with a predetermined category; an obtaining request sending module configured to, in response to determining that the content of the answer result is a part of content of the answer result, send to the server an obtaining request for obtaining a remaining part of content of the answer result; and a second content displaying module configured to, in response to receiving a second response comprising the remaining part of content of the answer result from the server, display the answer result comprising the part of content and the remaining part of content.

In accordance with a fifth aspect of the present disclosure, there is provided an electronic device, comprising at least one processor; and a memory for storing at least one program, the at least one program, when executed by the at least one processor, causing the at least one processor to implement the method according to the first aspect or the second aspect of the present disclosure.

In accordance with a sixth aspect of the present disclosure, there is provided a computer-readable storage medium stored thereon with computer programs, the computer programs, when executed by a processor, implementing the method according to the first aspect or the second aspect of the present disclosure.

In accordance with a seventh aspect of the present disclosure, there is provided a computer program product. The computer program product includes computer programs, when executed by a processor, implement the method according to the first aspect or the second aspect of the present disclosure.

It should be appreciated that the contents described in this Summary are not intended to identify key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for searching information according to some embodiments of the present disclosure;

FIG. 3 illustrates a schematic diagram of a further example method for searching information according to some embodiments of the present disclosure;

FIG. 4 illustrates a schematic diagram of an example flowchart for searching information according to some embodiments of the present disclosure;

FIG. 5 illustrates a schematic diagram of an example flowchart for obtaining the answer result according to some embodiments of the present disclosure;

FIG. 6 illustrates a schematic diagram of an example flowchart for obtaining the remaining part of content according to some embodiments of the present disclosure;

FIG. 7 illustrates a schematic diagram of an example of a streaming protocol for searching information according to some embodiments of the present disclosure;

FIG. 8 illustrates a schematic diagram of a further example of a streaming protocol for searching information according to some embodiments of the present disclosure;

FIG. 9 illustrates schematic diagram of an example of the answer result according to the embodiments of the present disclosure;

FIG. 10 illustrates a schematic diagram of an example of an exception page related to no network for searching information according to some embodiments of the present disclosure;

FIG. 11 illustrates a schematic diagram of an example of an exception page related to weak network for searching information according to some embodiments of the present disclosure;

FIG. 12 illustrates a schematic diagram of an example of an exception page related to fake network for searching information according to some embodiments of the present disclosure;

FIG. 13 illustrates a schematic diagram of an example of an exception page related to server crash for searching information according to some embodiments of the present disclosure;

FIG. 14 illustrates a schematic block of an apparatus for searching information according to embodiments of the present disclosure;

FIG. 15 illustrates a schematic block of a further apparatus for searching information according to embodiments of the present disclosure;

FIG. 16 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one example embodiment.” The terms “first”, “second” and so on can refer to same or different objects. The following text also may include other explicit and implicit definitions.

There are still many problems to be addressed during information searching. To search information on a client, e.g., a search interface on a smart phone, the users first input a text of a content to be searched into a search box of a browser and then click the search box. Afterwards, a search engine would display a search result on the search interface. At present, the search result related to the user query content is often presented on the browser page. Additionally, related videos and images may also be displayed on the browser page as results.

In the above traditional solution, the search result in general is directly obtained by the search engine from the database and returned to the search engine. For more common user query contents, the search engine may rapidly return the related contents in the database. However, in case that the user query is a long tail query corresponding to a small page view, the search engine may not find suitable information to be returned since the related contents of such query are rare in the database. Accordingly, the search recall rate may drop and the query result may not be obtained for some queries. The user experience thus declines. Further, in search scenarios, if a large language model is requested online to process the query, it may take a relatively long time to obtain data and the user experience is less satisfactory.

To at least solve the above and other potential problems, embodiments of the present disclosure provide a method for searching information. In this method, a server first determines whether a request content of a search request from a client is associated with a predetermined category, e.g., question and answer (Q&A) category. If the request content is associated with the predetermined category, a result identifier of an answer result for the search request is obtained from a machine learning model. Next, after obtaining the result identifier, the server would further obtain a part of content of the answer result generated by the machine learning model. The server would send the part of content to the client to be displayed. Subsequently, after receiving from the client an obtaining request for obtaining a remaining part of content of the answer result, the server obtains the remaining part of content generated by the machine learning model. In the end, the server sends the obtained remaining part of content to the client to display the answer result including the remaining part of content and the part of content. According to this method, after it is determined that the request content of the search request is associated with the predetermined category, the part of content of the answer result for the search request generated by the machine learning model is returned to the client and the remaining part of content obtained in subsequent operations is sent to the client to supplement the contents in the answer result. The problem that the answer result could not be provided to the users in time since the machine learning model fails to rapidly generate the answer result is thus addressed. Further, the recall rate for the search request is improved, the time consumed by the search request is lowered and the user experience is improved.

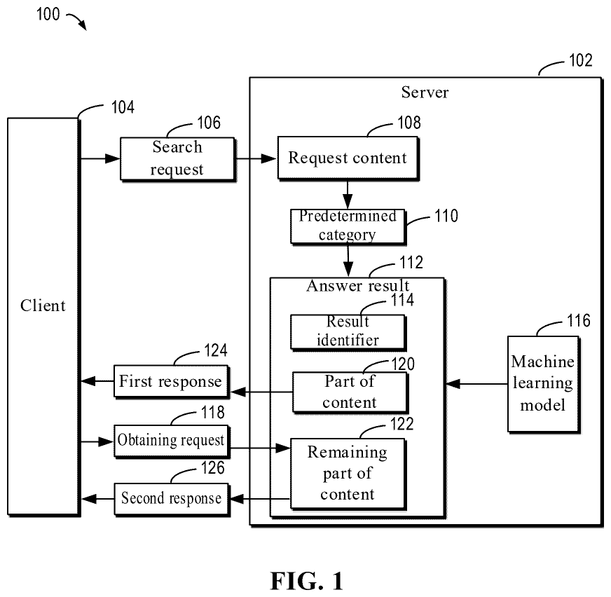

Embodiments of the present disclosure are to be described in details below with reference to the drawings, wherein FIG. 1 illustrates an example environment in which the device and/or method of the embodiments of the present disclosure may be implemented. In an environment 100, a server 102 first determines whether request content 108 of a search request 106 from a client 104 is associated with a predetermined category 110. If it is determined that the request content 108 of the search request 106 is associated with the predetermined category 110, the server 102 may process the request content 108 using a machine learning model 116 to obtain an answer result 112 and a result identifier 114 of the answer result. For example, the answer result 112 may be displayed as a Q&A card for the search request. After obtaining the result identifier 114, the server 102 may further obtain contents for the answer result 112 generated by a machine learning model 116 using the result identifier. If a part of content 120 of the answer result 112 is obtained, the server 102 would send the part of content 120 via a first response 124 to a client 104 to be displayed as the answer result 112 for the search request 106. Subsequently, after receiving from the client 104 an obtaining request 118 for obtaining a remaining part of content 122 of the answer result 112, the server 102 obtains the remaining part of content 122 generated by the machine learning model 116. In the end, after obtaining the remaining part of content 122, the server 102 sends the remaining part of content 122 via a second response 126 to the client 104, to display in the client 104 the answer result 112 including the remaining part of content 122 and the part of content 120.

Wherein examples of the server 102 include, but not limited to, a personal computer, a server computer, a multi-processor system, a minicomputer, a main frame computer and a distributed computing environment including any of the above systems or devices etc.

Examples of the client 104 include, but not limited to, a mobile phone (such as smartphone), a laptop computer, a Portable Digital Assistant (PDA), an electronic book (e-book) reader, a portable game machine, a portable media player, a game machine, a Set Top Box (STB), a smart television (TV), a personal computer, a laptop computer, an onboard computer (e.g., navigation unit) and the like.

The procedure for obtaining the answer result is to be depicted in details below. The server 102 first determines whether the request content 108 of the search request 106 from the client 104 is associated with the predetermined category 110. For example, the predetermined category may include a Q&A category and/or a category for obtaining information knowledge etc. In some embodiments, the server 102 determines whether the request content is associated with the predetermined category through a category discrimination model, wherein the category discrimination model may be trained using sample data. In some embodiments, the predetermined category is determined by judging whether a predetermined keyword is present in a set of keywords in the request content. In one example, if the request content contains the keyword of “how”, it may be judged that the request content is associated with the Q&A category. In another example, if the request content includes the keyword of “automobile development process”, it may be judged that the request content is associated with information knowledge category. The above example is provided merely for describing the present disclosure, rather than restricting it.

In case that the request content is not associated with the predetermined category, the search may be performed via a routine method. For example, corresponding information is retrieved in a database using a search engine. If the request content is associated with the predetermined category, the request content may be processed using the machine learning model to generate the answer result 112. For example, the machine learning model may be a large language model. Besides, apart from obtaining the answer result using the machine learning model, a common database retrieval operation is also performed via the search engine to obtain corresponding retrieval information from the database.

Then, after it is determined that the request content is associated with the predetermined category, the request content may be sent to the search engine and the result identifier 114 of the answer result may be obtained therefrom. The result identifier 114 may be used to obtain content for the answer result 112 from a repository for storing contents generated by the machine learning model 116. If the machine learning model 116 processes at a fast pace, all contents of the answer result may be obtained. At this moment, all content and research results may be directly returned to the client to be displayed as the answer result. However, it usually takes a relatively long time for the machine learning model to generate the answer result. In case that the answer result and the search result obtained by the search engine are to be returned together, the machine learning model 116 may only generate a part of content 120 of the answer result. At this moment, the server 102 forms the first response 124 from the obtained a part of content 120 and other search results and returns the first response to the client 104 to be displayed.

In some embodiments, after obtaining the first response, the client would display content of the answer result and/or the search result. Additionally, they may be displayed in one of the text form, image form and video form, or a combination thereof.

If the contents in the answer result are not the entire content, the client 104 here would further send to the server 102 an obtaining request 118 for obtaining the remaining part of content of the answer result. Afterwards, the server would further obtain the remaining part of content 122 generated by the machine learning model 116 and generate the second response 126 to provide the remaining part of content to the client to be displayed. Additionally, the procedure of obtaining the remaining part of content is implemented by a streaming protocol. For instance, the obtaining request 118 is sent via the streaming protocol and the server 102 provides a streaming response to the client 104.

Finally, after the client obtains the remaining part of content 122, the remaining part of content 122 and the part of content 120, as the answer result 112, are displayed in a search page of the client as one search result.

According to this method, after it is determined that the request content of the search request is associated with the predetermined category, the part of content of the answer result for the search request generated by the machine learning model is returned to the client and the remaining part of content obtained in subsequent operations is sent to the client to supplement the contents in the answer result. The problem that the answer result could not be provided to the users in time since the machine learning model fails to rapidly generate the answer result is thus addressed. Further, the recall rate for the search request is improved, the time consumed by the search request is lowered and the user experience is improved.

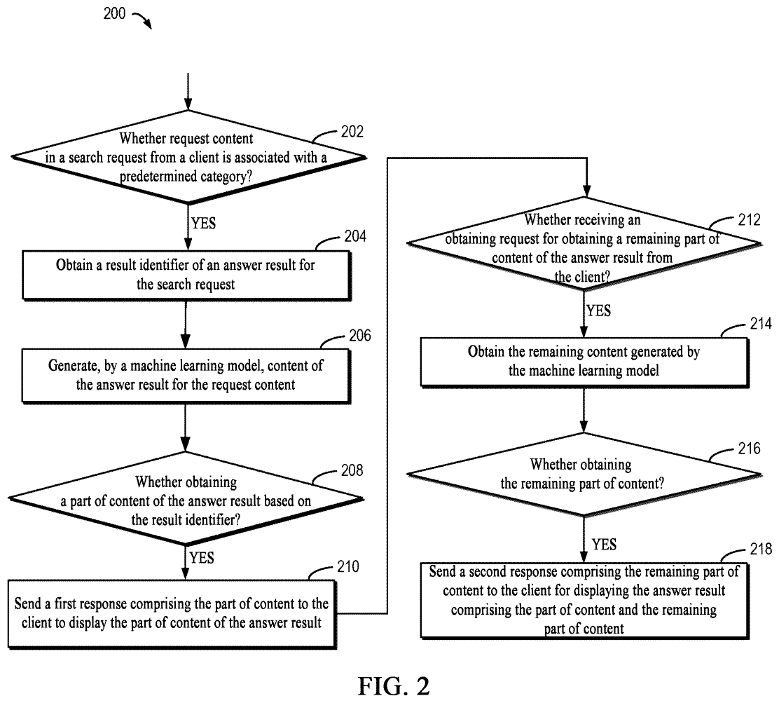

A schematic diagram of an example environment in which the device and/or method according to some embodiments of the present disclosure may be implemented has been described above with reference to FIG. 1. Next, a schematic diagram of an example method for searching information according to some embodiments of the present disclosure is to be depicted below with reference to FIG. 2. The method in FIG. 2 may be executed by the server 102 in FIG. 1 and/or any suitable devices.

As shown in FIG. 2, in the example method 200, after receiving the search request from the client, the server 102 would first determine whether the request content in the search request from the client is associated with the predetermined category at block 202.

Optionally, for the received search request, the server 104 may review the received search request. For example, the server 104 may retrieve or review whether the request content of the search request meets a predetermined requirement, e.g., whether the keyword in the request content is a restricted keyword or a keyword not allowed to be used. In one example, a keyword library is stored in the server 104 and restricted keywords or keywords not allowed to be used during search procedure are stored in the keyword library. Then, the review procedure is implemented by comparing keywords in the request content with the keywords in the keyword library. If the request content contains a keyword not meeting the predetermined requirement, the server 104 would generate a corresponding prompt message for the search request and send to the client to be displayed to the users. For example, the users are presented with a prompt saying that the search request could not be searched or the request content of the search request does not satisfy the requirement.

The server 104 may determine whether the request content of the search request is associated with the predetermined category directly or after the search request passes the review. For example, the server 104 may predict whether the search request is associated with the predetermined category using the category discrimination model. If a predicting result value is larger than a predetermined threshold, it is determined that the request content of the search request is associated with the predetermined category.

In some embodiments, the answer result for the search request provided to the client by the server may be fulfilled in various forms. In one example, the generated answer result is text information. In another example, the generated answer result may include text information and image information. In a further example, the generated answer result may include video information. The above examples are provided merely for describing the present disclosure, rather than restricting it.

If the request content in the search request from the client is associated with the predetermined category, the server 102 obtains the result identifier of the answer result for the search request at block 204. After it is determined that the request content is associated with the predetermined category, the request content may be sent to the search engine. In addition to searching in the database using the request content, the search engine may further provide the request content to the machine learning model, such as the large language model, for processing, to obtain the answer result for the request content. At this moment, the search engine may obtain the result identifier of the answer result. For example, if the answer result is the Q&A card, a document identifier of the Q&A card is obtained.

Afterwards, at block 206, the machine learning model generates contents of the answer result for the request content. As stated above, after it is determined that the request content is associated with the predetermined category, the server would send the request content to the machine learning model for processing. The result identifier for the answer result, after being obtained, may be utilized to obtain from the repository for storing content generated by the machine learning model contents corresponding to the result identifier, such as all or part of the content of the answer result.

At block 208, the server 102 would determine whether the part of content of the answer result is obtained based on the result identifier. In case that a corresponding content is obtained through the result identifier, it is determined whether the obtained content is the complete content or the part of content. If all of the content of the answer result is obtained, it indicates that a neural network model has completed processing the task. At this moment, the server may return the contents along with the retrieval result directly to the client. If it is determined that a part of content of the answer result is obtained, it suggests that the neural network model has not finished processing the task yet. In such case, the server 102 still sends a first response including the part of content of the answer result to the client for display of the part of content of the answer result at block 210.

While obtaining the content corresponding to the result identifier from the repository, the server 120 also may acquire an identifier indicating whether the content is the complete content. The server may send the identifier and the obtained content to the client 104.

After the content for the answer result and the identifier indicating whether the content is complete returned from the server are received, the client would display the complete content of the answer result along with other search results if it is determined that the content is complete according to the identifier. If it is determined that the content for the answer result received by the client is incomplete based on the identifier, i.e., only a part of content is obtained, the client may send to the server the obtaining request for obtaining the remaining part of content.

In some embodiments, after the content is obtained, the obtained content is directly displayed at the client in the form of text, image and/or video. In some embodiments, in case that the network of the client goes wrong, an error prompt message saying the answer result could not be displayed is displayed on the server and the search request for obtaining the answer result is automatically reissued at the client.

At block 212, the server 102 may further determine whether an obtaining request for obtaining the remaining part of content for the answer result is received from the client. If the obtaining request for obtaining the remaining part of content for the answer result is received from the client, the server 102 obtains the remaining part of content generated by the machine learning model at block 214.

After receiving the obtaining request for the remaining part of content, the server 104 would parse the obtaining request to obtain the result identifier for the answer result, and would subsequently obtain the remaining part of content for the result identifier from the Repository of the contents generated by the machine learning model based on the result identifier.

In some embodiments, prior to parsing the obtaining request, the server may first review the parameters in the obtaining request to ensure that the parameters meet the predetermined requirement. For example, the server may determine whether the obtaining request includes the result identifier for the answer result. If the obtaining request lacks the result identifier, the server could not obtain the information. Additionally, it may also be detected whether the obtaining request includes the user identifier among other information. Afterwards, the obtaining request, after passing the review, may be parsed. For example, to ensure data safety, the result identifier in the obtaining request is usually encrypted and the result identifier may be decrypted during the parsing of the obtaining request.

After the result identifier in the obtaining request is obtained, the server would further generate a polling task for the answer result in accordance with the result identifier, wherein the polling task is to constantly query the repository for storing the contents generated by the machine learning model to continually obtain the remaining part of content for the result identifier.

Additionally, to present more useful information to the users at the client, after the remaining part of content is obtained and the polling task for the answer result is completed, the server may further obtain a set of recommended words for the request content. For example, the recommended word corresponding to the request content is obtained via a recommendation word model or a recommendation word library. Then, the server sends a set of determined recommended words to the client to be displayed with the answer result.

In the end, the server 102 determines whether the remaining part of content is obtained at block 216. If the remaining part of content is not obtained, the server may try again. If the remaining part of content is obtained, the server sends a second response including the remaining part of content to the client to display the answer result including the part of content and the remaining part of content at block 218.

In some embodiments, the server may determine the streaming protocol available for transmitting data between the client and the server end for stream transmission of the data. Since it takes a quite long time to generate the remaining part of content, the stream transmission may greatly ease the poor user experience resulted from insufficient computing resources and time-consuming generation of the contents.

If the remaining part of content can be obtained, the server may further determine to use the streaming protocol to send the remaining part of content in the answer result to the client via a stream response for display. If the remaining part of content could not be obtained, the server also may send the stream response to the client according to the streaming protocol, so as to provide failure information and failure root to the client.

In case that the part of content for the answer result has been displayed and the remaining part of content is transmitted via the streaming protocol and displayed in streaming form at the client, the result content may be presented in stream fashion as the part of content is obtained faster than the remaining part of content. In this way, the user may gain a better experience while executing the search request.

After the remaining part of content is successfully obtained, a predetermined operation may be configured for the remaining part of content as required. In some embodiments, the remaining part of content may be added in the streaming form following the part of content of the answer result. In some further embodiments, some of the part of content may be substituted with the remaining part of content. For example, when some of the part of content is wrong or incompatible with the predetermined category, they may be replaced with the remaining part of content. In some other embodiments, the part of content may be partly or fully deleted.

In some embodiments, when the remaining part of content is not successfully obtained, the server would first determine the failure information stating that the remaining part of content is not successfully obtained. For example, a fault code of the failure information is determined to pinpoint the specific failure cause, and the failure information is then sent to the client through a response message.

In some embodiments, for the answer result, the server may add a like or dislike state to the answer result, and the like and dislike states may be stored at the local client in real time. Additionally, the like and dislike states may be updated through refreshing the answer result.

In some embodiments, the keyword in the answer result may also be clicked. For example, a long press on a certain keyword may initiate a new search.

In some embodiments, if the content in the answer result could not be displayed, for example, due to network issues, an exception page prompt message would be displayed in the answer result. For example, the prompt, such as “the page could not be displayed due to abnormal network”, is displayed. Additionally, the prompt messages of the exception page may also vary depending on different anomalies resulted from various situations.

In some embodiments, the frame of the answer result may also be self-adapted. For example, a total height of the frame of the answer result is determined according to a total height of texts in the answer result.

In some embodiments, an animation effect may also be added in the answer result. For example, in the procedure of obtaining the part of content or the remaining part of content related to the result identifier, the related animation effect may be added in the answer result, such that the users would not get bored while waiting.

Through this method, after it is determined that the request content of the search request is associated with the predetermined category, the part of content of the answer result for the search request generated by the machine learning model is returned to the users and the obtained remaining part of content is sent to the client in the subsequent operations to supplement the contents in answer result. Accordingly, the method solves the problem that the answer result could not be provided to the users in time as the machine learning model fails to rapidly generate the answer result. The recall rate for the search request is improved, the search request is less time-consuming and the user experience is enhanced.

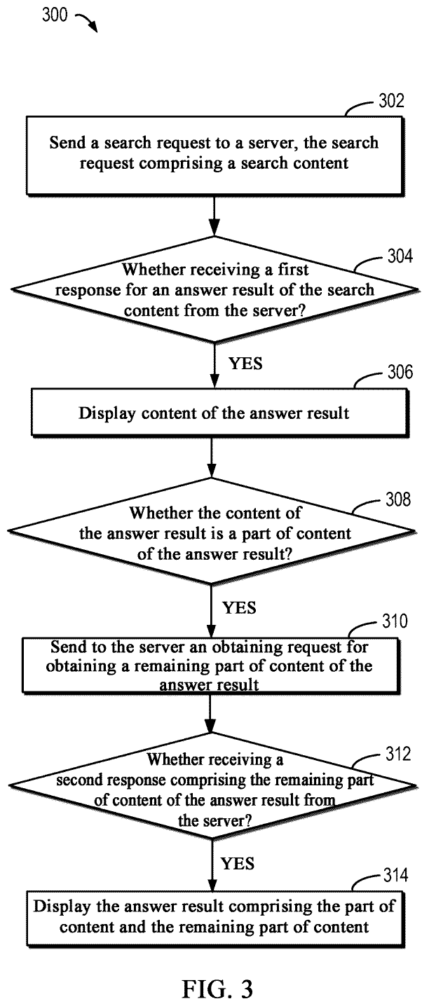

The schematic diagram of an example method for searching information at the server end in accordance with some embodiments of the present disclosure has been described above with reference to FIG. 2. Next, a schematic diagram of an example method for searching information at the client in accordance with some embodiments of the present disclosure is to be depicted in conjunction with FIG. 3. The method 300 may be executed by the client 104 in FIG. 1 or any other suitable computing devices.

In the example 300, at block 302, after receiving the user input, the client sends the search request to the server, wherein the search request includes the search content. While searching the information at the client, the user may input the search content in a search interface. Then, the client 104 may generate the search request according to the search content input by the user and send the search request to the server 102.

At block 304, the client 104 determines whether the first response for the answer result of the search content is received from the server. If the first response for the answer result of the search content is received from the server, the client 104 displays the content of the answer result at block 306. The answer result is obtained from sending the request content to the machine learning model for processing after the server 102 determines that the request content is associated with the predetermined category.

In some embodiments, the first response received from the server also may include a set of search results. The client obtains from the first response a set of search results and the answer result. Afterwards, the set of search results and the answer result are presented to the user of the client.

At block 308, the client also may further determine whether the content of the answer result is a part of content of the answer result. In some embodiments, the first response may include an integrity identifier configured by the server for indicating whether the content of the answer result is integral. The client may obtain information of the integrity identifier from the first response. Then, the client judges the integrity identifier to determine that the content of the answer result is the part of content of the answer result. For example, the integrity identifier with a first predetermined value indicates completeness and the integrity identifier with a second predetermined value represents incompleteness.

If it is determined that the content of the answer result is the part of content of the answer result, the client 104 sends to the server 102 the obtaining request for obtaining the remaining part of content of the answer result at block 310. At this point, the client also may obtain from the first response the result identifier of the answer result and add the result identifier into the obtaining request. Additionally, the client may encrypt the result identifier to generate an encrypted result identifier and the encrypted result identifier is then placed in the obtaining request. Further, the client 104 also may add the user identifier and the request content into the obtaining request.

At block 312, the client 104 determines whether a second response including the remaining part of content of the answer result is received from the server. If it is determined that a second response including the remaining part of content of the answer result is received from the server 102, the client 104 would display the answer result including the part of content and the remaining part of content at block 314.

In some embodiments, the second response also may include a set of operations for the remaining part of content, such as addition operation, replacement operation and/or deletion operation. Therefore, while displaying the answer result including the part of content and the remaining part of content, the client also may obtain a set of operation identifiers, then process the remaining part of content and the part of content using a set of operations corresponding to the set of operation identifiers, and display the processed content.

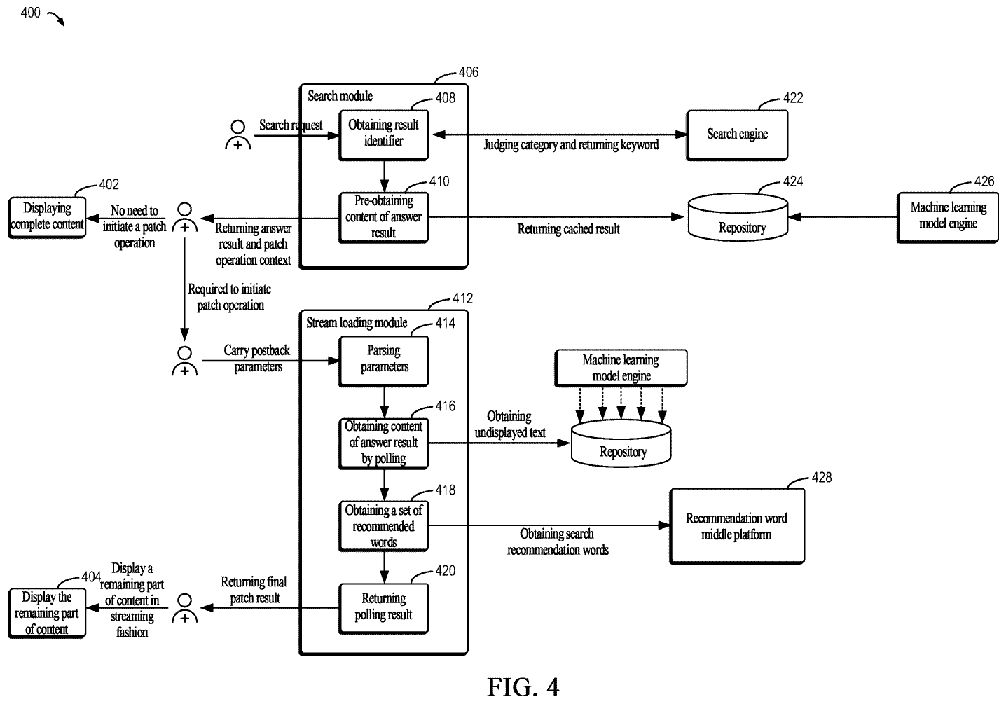

The schematic diagrams of example flowcharts for searching information according to some embodiments of the present disclosure have been described above with reference to FIGS. 2 and 3. Next, a schematic diagram of an example flowchart for searching information according to some embodiments of the present disclosure is to be depicted with reference to FIG. 4. The example of FIG. 4 may be executed by the server 102 in FIG. 1 or any other suitable devices.

In the example 400, a search module 406 may receive the search request from the client. At block 408, the search module 406 obtains the result identifier through communicating with a search engine 422. In this procedure, the search module may determine whether the request content in the search request is associated with the predetermined category. Then, the request content is sent to the search engine 422 to perform the search. If the request content is not associated with the predetermined category, the search engine 422 returns the content searched from the database to the client. If the request content is associated with the predetermined category, the search engine 422 may further utilize the machine learning model 426 to process the request content, e.g., the request content is processed using a large language model engine. Accordingly, the search engine 422 may return the result identifier of the answer result generated for the request content to the search module 406. Afterwards, the search module 406 pre-obtains the content of the answer result at block 410. In this procedure, the search module 406 obtains the corresponding content from the repository for storing contents generated by the machine learning model engine 426 using the result identifier. The search module 406 returns the obtained content of the answer result to the client to be displayed. In addition to the content of the answer result, the search module 406 also may send to the client context of a patch operation related to the answer result. The patch operation context includes the result identifier and an identifier indicating whether the returned content is a complete content.

If the client determines through the patch operation context that the complete content of the answer result is obtained, the complete content is displayed on the client at block 402. Besides the complete content of the answer result, other information retrieved from the database by the search engine may also be displayed simultaneously. For example, the answer result is displayed first, followed by the search result.

If determining that the complete content of the answer result is not obtained according to the patch context, the client would determine to initiate a patch operation for obtaining the remaining part of content of the answer result. Then, the client sends the obtaining request for obtaining the remaining part of content corresponding to the patch operation. The request includes postback parameters, and the postback parameters may include the encrypted result identifier.

After a stream loading module 412 of the server receives the obtaining request, the parameters are parsed at block 414. For example, the server may decrypt the encrypted result identifier to determine the result identifier for obtaining the remaining part of content. Then, the content of the answer result is obtained by polling at block 416. At this point, the server would further utilize the obtained result identifier to generate a polling task for the answer result, which polling task is provided for constantly obtaining the remaining part of content for the result identifier from the repository of the contents generated by the machine leaning model.

After the remaining part of content is obtained and the polling task for the answer result is completed, a set of recommended words may be further obtained at block 418. The obtained set of recommended words may be sent to the client to be displayed on the answer result. In one example, the obtaining request includes the request content of the search request of the user. The recommended word is generated by a recommendation word middle platform 428 according to the request content.

Then, the polling result is returned at block 420. The server would return the remaining part of content. In this procedure, the server returns the remaining part of content to the client in the streaming form through the streaming protocol. After the client receives the remaining part of content, the remaining part of content 404 is displayed in the answer result of the client.

Accordingly, the above procedure may avoid filtering out part of the answer result due to an excessively long write time of the machine learning model (such as large language model).

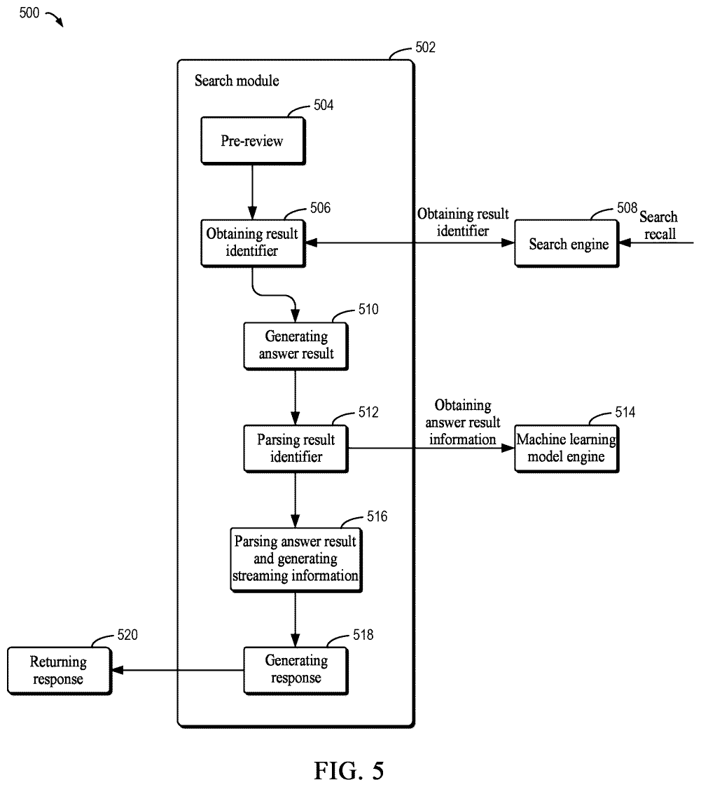

The schematic diagram of an example flowchart for searching information according to some embodiments of the present disclosure has been described above with reference to FIG. 4. Next, a schematic diagram of an example flowchart for obtaining the answer result for search information according to some embodiments of the present disclosure is to be depicted below with reference to FIG. 5. The example 500 is an example of the search module in the example 400.

In the example 500, a search module 502 may receive the search request from the client 104. At block 504, the search module would conduct a pre-review on the request content in the search request. For example, it is reviewed whether the request content contains sensitive words and restricted words etc. If the sensitive words or the restricted words are present, the search request will fail the pre-review. At this moment, an error prompt response is returned to the client. For example, the prompt like “the search request could not be executed” or “server error” is returned to the client.

After the search request passes the pre-review, the search module 502 obtains the result identifier through the search engine 508 at block 506. In this procedure, the search module 502 may further determine whether the request content is associated with the predetermined category. For example, the search module 502 may detect whether the request content is associated with a Q&A category or a knowledge acquisition category. In other words, the search module 502 determines a possibility of the machine learning model engine for providing an answer to the request content. If the search content is not associated with the predetermined category, the search content is sent to the search engine for search recall. The search result is then returned to the client to be presented to the user.

If it is determined that the search content is associated with the predetermined category, the search module 502 would send the search content to the search engine 508, which search engine 508 would also send the search content to the machine learning model engine to be processed. Since it takes a certain period of time for the machine learning model engine to process the search content and provide an answer, the search engine 508 would obtain the result identifier corresponding to the answer result generated by the machine learning model engine. Further, the search engine 508 also may further obtain the search result resulted from searching in the database. Accordingly, the search engine may return the result identifier along with the corresponding search result to the search module 502. After obtaining the result identifier, the search module 502 would begin the operation of generating the answer result at block 510. In this procedure, the search module 502 parses the result identifier at block 512. For example, the result identifier is retrieved from the information including the result identifier returned from the search engine. Then, the result identifier is sent to the corresponding repository of the machine learning model engine 514 to obtain the content of the answer result. At block 516, the search module 502 parses the answer result and generates the streaming information. The streaming information, for example, may be the text of the answer content. Next, the search module further generates a response 518 according to the obtained content and then returns the response to the client 104 at block 520. In the response, an identifier indicating whether the answer content is a complete answer content may be added.

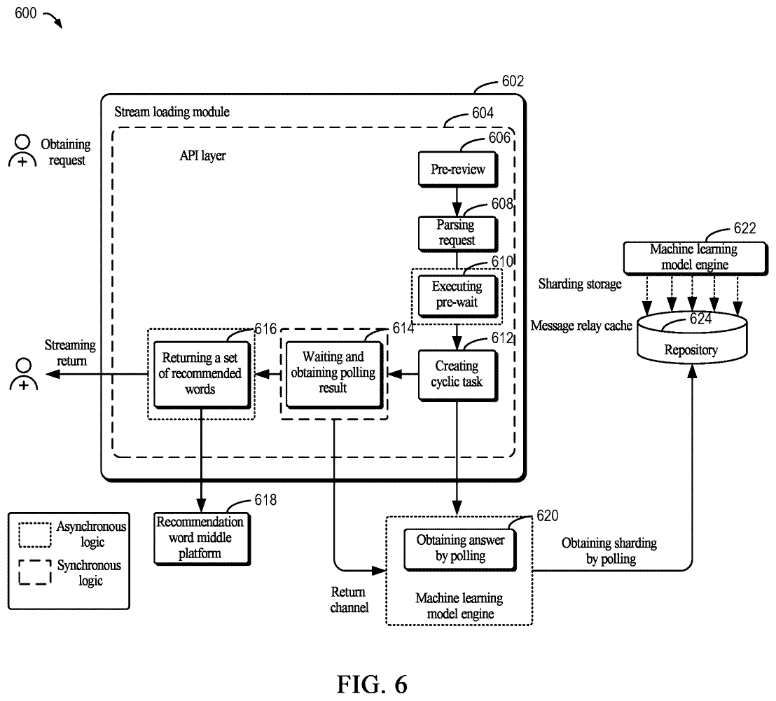

The schematic diagram of an example flowchart for obtaining the answer result according to some embodiments of the present disclosure has been described above with reference to FIG. 5. Next, a schematic diagram of an example flowchart for obtaining the remaining part of content according to some embodiments of the present disclosure is to be depicted below with reference to FIG. 6. The example 600 is provided for the stream loading module in the example 400.

The stream loading module 602 may obtain from the client. the obtaining request for obtaining the remaining part of content. The stream loading module 602 contains one Application Programming Interface (API) layer. In this layer, after the obtaining request for the remaining part of content is obtained, a pre-review is performed on the obtaining request at block 606. Parameters in the obtaining request are correspondingly reviewed in the pre-review. For example, it is checked whether the parameters in the obtaining request comply with a format; a safety check is performed on the parameters; and it is reviewed whether the parameters required for parsing the obtaining request is contained. For example, it is detected whether the obtaining request includes the result identifier and/or the user identifier etc. If the obtaining request fails to pass the pre-review, the stream loading module returns a response indicating that the information could not be obtained.

If the obtaining request passes the pre-review, the request is parsed at block 608. For example, the result identifier in the obtaining request is encrypted to avoid information leakage. During the parsing of the obtaining request, the encrypted result identifier is decrypted to obtain the result identifier.

After the result identifier is obtained, a pre-wait may be executed at block 610 to wait for the machine learning model engine 622 to generate the result content since it takes a relatively long time for the machine learning model engine to generate the answer result. This operation may be an asynchronous operation. Then, at block 612, the stream loading module creates a cyclic task, to interact with the machine learning model through the cyclic task, thereby obtaining the answer by polling at block 620. The machine learning model engine may obtain the remaining part of content of the answer result by polling from the repository 624 for storing the contents in the machine learning model engine 622. At block 614, the stream loading module waits and obtains a polling result. In this procedure, for example, channels for data interactions may be sent to the machine learning model to implement data exchange.

Additionally, the server would also return a set of recommended words 616, which set of recommended words are obtained from a recommendation word middle platform 618. Finally, the remaining part of content and the set of recommended words are returned in the streaming form through the streaming protocol to the client for display.

In some embodiments, the pre-wait, the return of a set of recommended words, and the obtaining of the answer by polling are executed asynchronously, while other procedures are performed synchronously. Due to the asynchronous execution of the above three procedures, the return and the display for the part of content would not be affected during the procedure of waiting for the remaining part of content to be returned. The experience of the user may be enhanced while waiting for the remaining part of content.

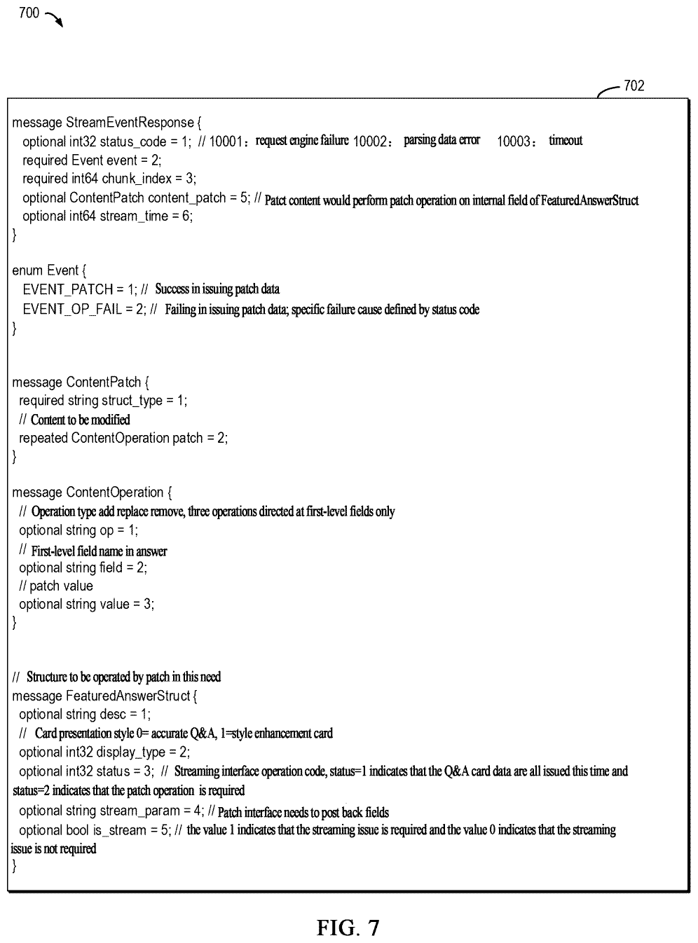

The schematic diagram of an example flowchart for obtaining the remaining part of content according to some embodiments of the present disclosure has been described above with reference to FIG. 6. Next, a schematic diagram of an example of a streaming protocol for searching information according to some embodiments of the present disclosure is to be depicted below with reference to FIG. 7.

In the example 700, the answer result may be a Q&A card. As demonstrated by block 702, StreamEventResponse function, Event function, ContentPatch function, ContentOperation function and FeaturedAnswerStruct function are included, where patch represents the remaining part of content.

StreamEventResponse function defines three status codes, respectively being 10001 for indicating request engine failure, 10002 for representing data parsing error and 10003 denoting timeout.

Event function defines two statuses with respect to obtaining of the remaining part of content, respectively being EVENT_PATCH=1 indicating a success in issuing the remaining part of content, and EVENT_OP_FAIL=2 denoting failure in issuing the remaining part of content. The specific failure cause is defined according to the status code.

In the ContentPatch function, struct_type=1 indicates the content to be amended. Besides, the ContentOperation function defines three types of operations: addition, replacement and deletion (respectively being add, replace and remove).

In the StreamEventResponse function, desc=1 indicates a card presentation style, wherein 0 refers to an accurate Q&A card and 1 represents a style enhancement card. Status=3 denotes a streaming interface operation code, where status=1 indicates that the Q&A card data is all issued this time and status=2 denotes that it is required to perform operations on the remaining part of content. By stream_param=4, it indicates that the remaining part of content interface needs a postback field. In optional bool is_stream=5, the value 1 indicates that the streaming issue is required and the value 0 suggests that the streaming issue is not required.

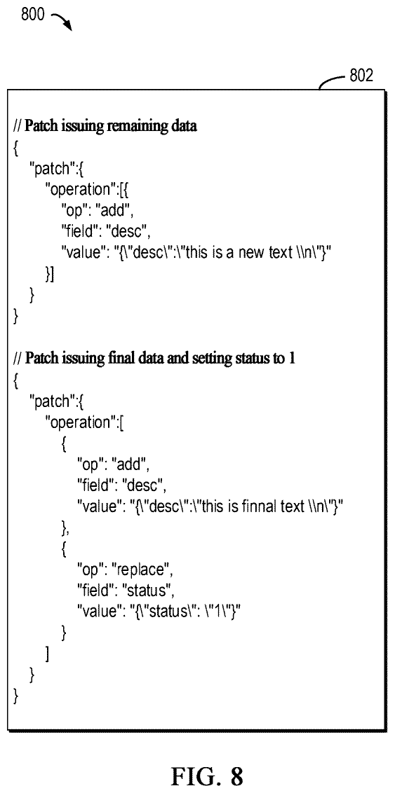

The schematic diagram of an example of a streaming protocol for searching information according to some embodiments of the present disclosure has been described above with reference to FIG. 7. Next, a schematic diagram of a further example of a streaming protocol for searching information according to some embodiments of the present disclosure is to be depicted below with reference to FIG. 8.

In the example 800, as shown in block 802, the code instance includes two parts. The first part of the code indicates that the remaining part of data are issued by patch, i.e., the remaining part of content is sent to the client. The second part of the code indicates that the final data are issued by patch. Different operations are performed on various fields. For example, a replacement operation is executed on status and the status is set to 1.

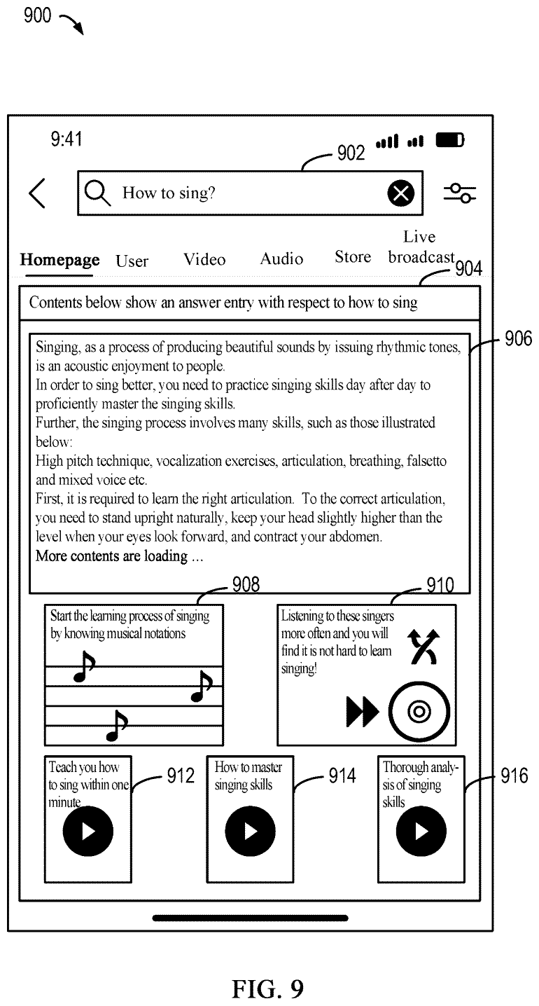

A schematic diagram of an example of the answer result according to the embodiments of the present disclosure is to be depicted below with reference to FIG. 9.

In the example 900, a search box 902 contains the request content including “how to sing?”. It is determined whether the request content is associated with the predetermined category. For example, the category discrimination model determines whether the request content is associated with the predetermined category.

After it is determined that the request content is associated with the predetermined category, the result identifier for the answer result is further obtained. Then, the obtained result identifier is utilized to search in the repository of the contents generated by the machine leaning model the part of content matching with the result identifier.

The part of content, after being obtained, is returned to a search result box 904 of the client in text form and displayed in a text box 906 for the part of content in text form. In addition, the height of the text box is determined in accordance with the height of the text of the part of content, such as the number of lines of the text.

Besides, after the part of content of the answer result is displayed in the text box 906, the remaining part of content for the request content is further obtained from the repository. For example, below the text corresponding to the part of content in the text box 906, “loading more content” is added and displayed to return the successfully obtained remaining part of content to the client and display it below the part of content of the text box.

In some embodiments, after the remaining part of content is successfully obtained and sent to the client, the prompt message of “loading more contents” is added below the part of content. Alternatively, after the client obtains the part of content, the prompt message of “loading more contents” is directly added below the part of content.

In some embodiments, after the part of content and the remaining part of content are displayed in the answer result, image data 908 and image data 910 for the request content may also be obtained. The image data are data retrieved by the search engine from searching in the database. In addition, the image data both include a uniform resource identifier, and a click operation for the image may be received to jump to a page or resource corresponding to the uniform resource identifier.

In some embodiments, the answer result also may include video data 912, video data 914 and video data 916. The video data are also found by the search engine through searching and matching in the database and returned to the client. In some embodiments, the click operation for the video may be received to directly play the corresponding video.

In some embodiments, when the content in the answer result is being generated, the client switches from “Home Page” to “video” page and the display of the content for the answer result is stopped. When the client switches back to “Home Page” from “video” page, the answer result is displayed again from the position where the display stops.

In the present disclosure, some modules may be added in the page presented at the client. In some embodiments, an interaction module may be added in the page. In one example, the interaction module of the page may be present when the streaming request for the stream loading module finishes. The interaction module of the outflow card is presented only when an experimental group of a first new component is hit, and the presentation occasion is when the outflow card is performing the height increase animation. Besides the addition of the interaction module, a synchronization logic of the like state of the inflow and outflow may also be added: when the search page is opened, the locally stored like state is obtained according to the result identifier of the search result issued by a comprehensive search request, and the latest like state is displayed; the current state, when a like or dislike is given, is stored locally and the data cache logic remains consistent with the interaction component of the outflow card. In addition, in case of returning to the outflow card from the page, the local storage state is obtained and the like state of the interaction component is refreshed (an API for refreshing the user interface may be added in the component). In another example, like, dislike and feedback modules are added. The page is presented when the presentation of the text content of the inflow page is completed (after receiving the replace=1 of the block request), wherein the likes and dislikes read the locally stored like and dislike information according to the result identifier, which is synchronized with the outflow. In case of returning to the outflow from the detail page, it is required to call the like or dislike information of the interaction component again.

In some embodiments, a search recommendation module may be added in the page. The search recommendation module is presented when the streaming request finishes. The recommended search word is obtained from the stream loading module. The server may be added with a new module to return all recommended search words. The recommended search word is clicked to initiate a new search. A feedback panel pops up by a long press to interact and align with the outflow recommended search card. Recommended search data may be parsed and a module (chunk event=4) is added to receive the recommended search words. The search may be initiated by click to align with the parameter transfer logic of the outflow recommended search words. The feedback panel is invoked by a long press.

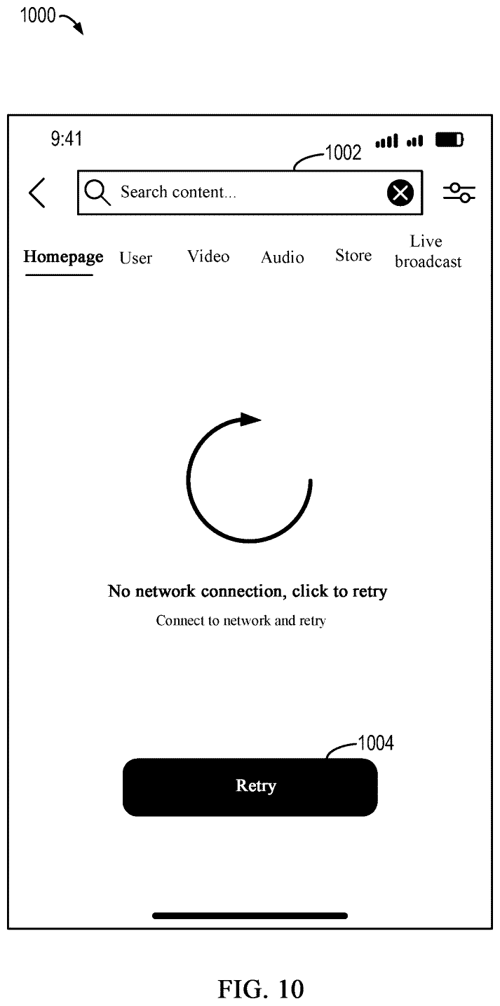

In some embodiments, an exception page may be provided for presenting abnormal information. When the stream loading module could not obtain the remaining part of data or has no access to network, it is required to display a retry page. Prompt texts of the two pages follow the search scenario specification. The search page uniform state component is mounted in the root layout of the page. For example, a prompt saying “no network connection and click to retry” is present in case of no network. In case that the obtaining request for the stream loading module fails, it is prompted that “something went wrong”. In some embodiments, the conditions of the exception page including no network, weak network and fake network may also be configured as shown in FIGS. 10-13.

A schematic diagram of an example of an exception page related to no network for searching information according to some embodiments of the present disclosure is to be described below with reference to FIG. 10.

In the example 1000, the search request is executed in the search box 1002; in case of no networks, the text prompt message of “no network connection, click to retry” is displayed at the client interface while a prompt message of “connect to network and retry” in small character is displayed below. In addition, a retry control 1004 is displayed at the client interface.

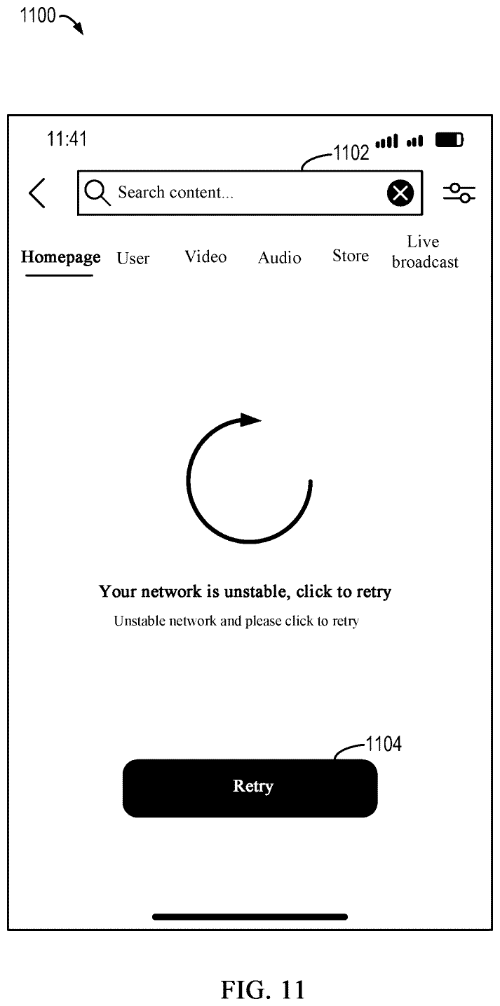

The schematic diagram of an example of an exception page related to no network for searching information according to some embodiments of the present disclosure has been described above with reference to FIG. 10. Next, a schematic diagram of an example of an exception page related to weak network for searching information according to some embodiments of the present disclosure is to be described below with reference to FIG. 11.

In the example 1100, the search request is performed in the search box 1102; in case of weak networks, the text prompt message of “your network is unstable, click to retry” is displayed at the client interface while a prompt message of “unstable network and please click to retry” in small character is displayed below. In addition, a retry control 1004 is displayed at the client interface.

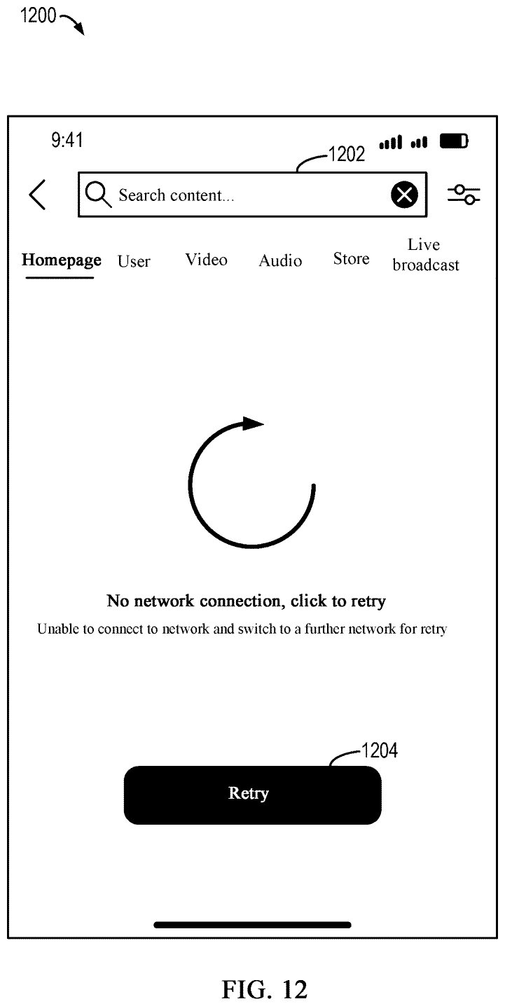

The schematic diagram of an example of an exception page related to weak network for searching information according to some embodiments of the present disclosure has been described above with reference to FIG. 11. Next, a schematic diagram of an example of an exception page related to fake network for searching information according to some embodiments of the present disclosure is to be described below with reference to FIG. 12.

In the example 1200, the search request is executed in the search box 1202; if the network is a fake one, the text prompt message of “no network connection, click to retry” is displayed at the client interface while a prompt message of “unable to connect to network and switch to a further network for retry” in small character is displayed below. In addition, a retry control 1204 is displayed at the client interface.

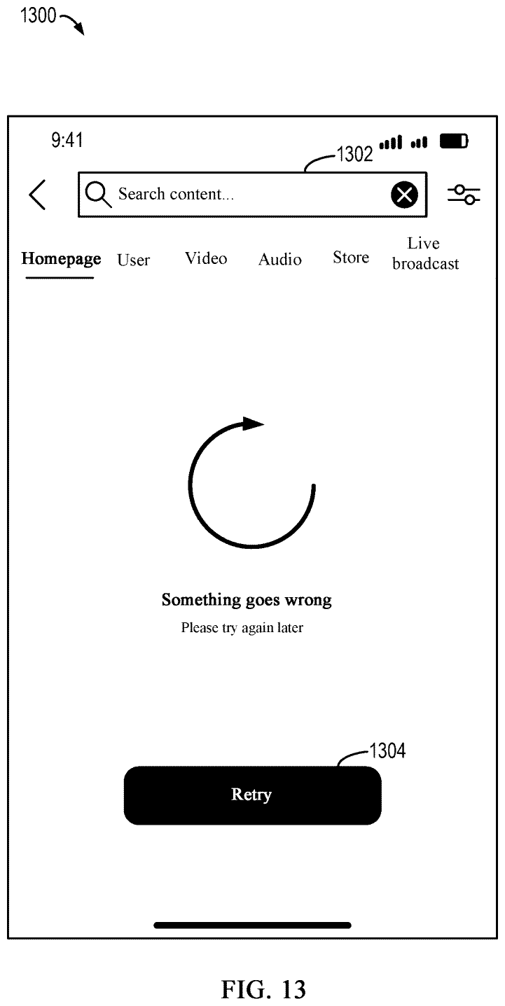

The schematic diagram of an example of an exception page related to fake network for searching information according to some embodiments of the present disclosure has been described above with reference to FIG. 12. Next, a schematic diagram of an example of an exception page related to server crash for searching information according to some embodiments of the present disclosure is to be described below with reference to FIG. 13.

In the example 1300, the search request is executed in the search box 1302; in such case, in case of server crash or server exception, the text prompt message of “something goes wrong” is displayed at the client interface while a prompt message of “please try again later” in small character is displayed below. In addition, a retry control 1304 is displayed at the client interface.

In some embodiments, for outflow cards, a sublink module may be added below the answer result. Here, the logic for height increase animation of may be modified: the original answer page includes texts only and the height increase animation is fulfilled in a container layer of the entire card. Besides, a sublink height is added to the newly added sublink module and such information should be considered for calculating the height increase. To facilitate subsequent iteration of the new module, the height increase animation may be migrated to a layer of text view. The height of the card layer is self-adapted to the height of the internal element. Additionally, clicking the text may jump to a page and synchronously refresh text content of the page. At this point, chunk data received by the comprehensive search page may be forwarded to Activity component using a specific module to refresh texts.

In some embodiments, new loading animation pages may also be added. Further, a predetermined text skeleton component may also be used. It is controlled by setting to display two lines of text skeleton and a skeleton height may be set. In addition, the animation may also be inserted to the end of the text or dynamic loading effects may be added.

In some embodiments, label components may be added in the loading page and the retry page. In the pages, a layout position where the label component is mounted may be modified. For example, the label component may be moved to the root layout of the card and this involves modifications of certain data transfer. The current answer text may be obtained from the card level to construct data of the label component, such as model of a single feedback panel.

In some embodiments, a reference sublink module may be employed. A reference corner mark in the text depends on the serving end issuing the markdown format of <sup> the corner mark sequence <sup> to the client for parsing and rendering. Link skipping data corresponding to the reference corner mark are received by adding a network document list in the answer result, and patches of the streaming loading request or the remaining part of content would also be issued one by one according to the corner mark sequence. After parsing the data in real time, the client updates the network document list in the answer result. In one example, in case of height increase animation of the outflow card, the reference sublink module is presented according to the link skipping list obtained at that moment. However, it is possible that the number of links displayed by the reference module is greater than the number of corner marks of the outflow card since the final corner marks in the outflow card may be omitted due to text truncation. In another solution, the experimental group of the new component is implemented to improve the external provision capability of the text component. The number of reference corner marks contained in the text actually presented by the outflow card is obtained. In view of the actually presented number, the first several links are removed from the existing network document list for displaying. Moreover, in the interactions of user interface, the provided streaming layout components may support restricting the maximum number of lines for presentation. A view may be added at the end of the maximum number of lines, such that a general layout may add an unfold button at the end of the streaming layout component. By clicking the unfold button, all sub-views are unfolded and a state of the button at the end is updated to be collapsible.

In some embodiments, sublink logic of a chatting page may be multiplexed. This may lead to unbinding from modules of models. In this embodiment, the data of all sublinks to be presented may be obtained first and a width of the current sublink may be calculated according to a text length of the sublink. If the width has already exceeded a stipulated width, the data are placed in a next line. Frame of each sublink is dynamically adjusted during the placement. At the data layer, in case that the outflow page is required to present the new button in real time, an operation of the additional button is provided during design, to provide real-time update capability. In accordance with the link information issued by blocks in real time, the outflow card presents the link information in real time. In the inflow detail page, if the user is in the inflow page, the information indicating receipt of the link would not be demonstrated in real time. Instead, the information is cached first and then uniformly displayed after a flag bit (replace==1) representing the end of the text portion is received.

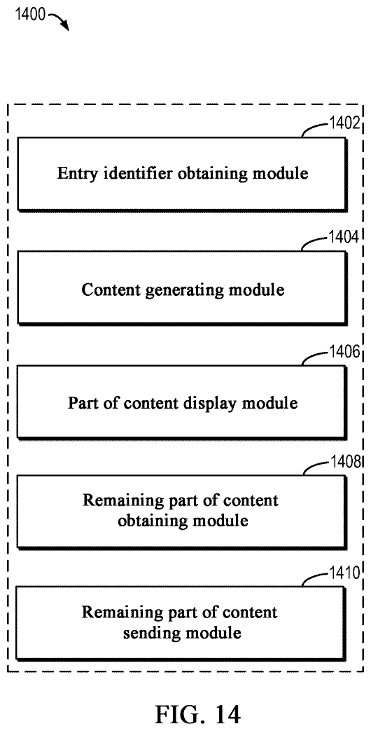

A schematic block of an apparatus 1400 for searching information according to embodiments of the present disclosure is to be described below with reference to FIG. 14.

As shown in FIG. 14, the apparatus comprises a result identifier obtaining module 1402 configured to, in response to determining that request content in a search request from a client is associated with a predetermined category, obtain a result identifier of an answer result for the search request; a part of content generating module 1404 configured to generate, by a machine learning model, a content of the answer result for the request content; a part of content display module 1406 configured to, in response to obtaining a part of content of the answer result based on the result identifier, send a first response comprising the part of content to the client to display the part of content of the answer result; a remaining part of content obtaining module 1408 configured to, in response to receiving from a client an obtaining request for obtaining a remaining part of content of the answer result, obtain the remaining part of content generated by the machine learning model; and a remaining part of content sending module 1410 configured to, in response to obtaining the remaining part of content, send a second response comprising the remaining part of content to the client for displaying the answer result comprising the part of content and the remaining part of content.

In some embodiments, the result identifier obtaining module 1402 includes: a request content sending module configured to, in response to the request content of the search request from the client being associated with the predetermined category, send the request content to the machine learning model; and the result identifier obtaining module is configured to, in response to the request content being processed by the machine learning model, obtain the result identifier for identifying the answer result generated by the machine learning model.

In some embodiments, the apparatus 1400 also comprises: a result identifier sending module configured to send the result identifier to a repository for storing content generated by the machine learning model; and the part of content obtaining module is configured to obtain content of the answer result corresponding to the result identifier from the repository.

In some embodiments, the remaining part of content obtaining module 1408 includes: an obtaining request receiving module configured to receive the obtaining request for obtaining the remaining part of content of the answer result from the client; an obtaining request parsing module configured to obtain the result identifier for the answer result by parsing the obtaining request; and the remaining part of content obtaining module is configured to obtain, based on the result identifier, the remaining part of content generated by the machine learning model.

In some embodiments, the obtaining request parsing module includes: a parameter review module configured to review parameters in the obtaining request; and a parameter parsing module configured to, in response to determining that the parameters satisfy a predetermined requirement, parse the obtaining request.

In some embodiments, the obtaining request includes an encrypted result identifier, and the parameter parsing module includes: a result identifier decrypting module configured to obtain the result identifier by decrypting the encrypted result identifier.

In some embodiments, the remaining part of content obtaining module also includes: a polling task generating module configured to generate, based on the result identifier, a polling task for the answer result; and the remaining part of content obtaining module is configured to obtain, based on the polling task, the remaining part of content from a repository for storing content generated by the machine learning model.

In some embodiments, wherein the obtaining request also includes the request content of the search request, and the remaining part of content obtaining module also includes: a module for determining a set of recommended words configured to, in response to completion of the polling task, determine a set of recommended words for the request content; and a module for sending a set of recommended words configured to send the set of recommended words to the client to be displayed simultaneously with the answer result.

In some embodiments, the remaining part of content sending module 1410 includes: a streaming protocol determining module configured to determine a streaming protocol for the answer result; and a remaining part of content providing module configured to provide, based on the streaming protocol, a second response comprising the remaining part of content to the client.

In some embodiments, the remaining part of content providing module includes: a module for determining that the remaining part of content has been successfully obtained, the module being configured to determine that the remaining part of content has been successfully obtained; a module for determining a set of predetermined operation configured to determine a set of predetermined operations to be executed for the remaining part of content; and a second response sending module configured to send, based on the streaming protocol, the second response to the client, where the second response comprises an identifier indicating that the remaining part of content has been successfully obtained, a set of operation identifiers for the set of predetermined operations and the remaining part of content.

In some embodiments, the set of predetermined operations comprise at least one of: addition operation, replacement operation and deletion operation.

In some embodiments, the remaining part of content providing module also includes: a module for determining that the remaining part of content is not successfully obtained, the module being configured to determine that the remaining part of content is not successfully obtained; a failure information determining module configured to determine failure information indicating that the remaining part of content is not successfully obtained; and a third response sending module configured to send, based on the streaming protocol, a third response to the client, wherein the third response comprises an identifier indicating that the remaining part of data are not successfully obtained and an identifier of the failure information.

In some embodiments, the apparatus 1400 also comprises: a search request receiving module configured to receive the search request from the client; a review module configured to determine whether a predetermined keyword is present in the request content by reviewing the request content of the search request; and a predetermined category determining module configured to, in response to determining absence of the predetermined keyword in the request content, determine whether the search request is associated with the predetermined category.

In some embodiments, the apparatus 1400 also comprises: a prompt message sending module configured to, in response to determining presence of the predetermined keyword in the request content, send a prompt message for the search request to the client.

In some embodiments, the answer result comprises at least one of: text data, image data or video data.

In some embodiments, the apparatus 1400 also comprises: a search result determining module configured to determine, based on the request content, a set of search results for the request content; and a first response generating module configured to generate the first response based on the search result and the part of content.

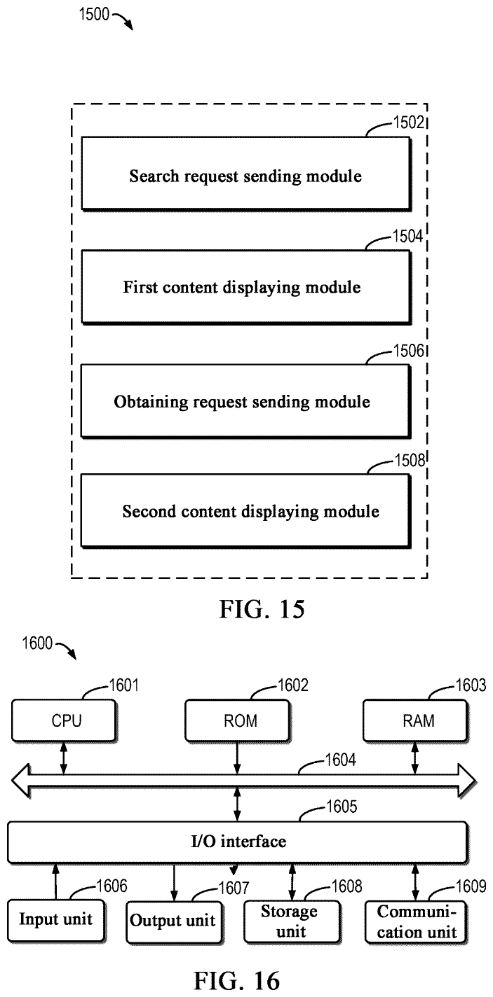

A schematic diagram of an apparatus 1500 for searching information according to embodiments of the present disclosure is to be depicted below with reference to FIG. 15. As shown in FIG. 15, the apparatus 1500 comprises a search request sending module 1502 configured to send a search request to a server, the search request comprising a search content; a first content displaying module 1504 configured to, in response to receiving a first response for an answer result of the search content from the server, display content of the answer result, wherein the answer result is generated by a machine learning model on the basis of a determination that the search content is associated with a predetermined category; an obtaining request sending module 1506 configured to, in response to determining that the content of the answer result is a part of content of the answer result, send to the server an obtaining request for obtaining a remaining part of content of the answer result; and a second content displaying module 1508 configured to, in response to receiving a second response including the remaining part of content of the answer result from the server, display the answer result comprising the part of content and the remaining part of content.

In some embodiments, wherein the first response comprises a set of search results and the first content displaying module 1504 includes: a result obtaining module configured to obtain the set of search results and the answer result from the first response; and a third content displaying module configured to display the answer result and the set of search results.

In some embodiments, the apparatus 1500 also comprises: an integrity identifier obtaining module configured to obtain an integrity identifier for indicating whether content of the answer result is integral in the first response; and a part of content determining module configured to determine, based on the integrity identifier, whether the content of the answer result is a part of content of the answer result.

In some embodiments, the apparatus 1500 also comprises: a result identifier obtaining module configured to obtain a result identifier of the answer result from the first response; and a request generating module configured to generate the obtaining request based on the result identifier.

In some embodiments, the request generating module includes: an encryption module configured to generate an encrypted result identifier by encrypting the result identifier; and an obtaining request generating module configured to generate, based on the encrypted result identifier, the obtaining result.

In some embodiments, the second content displaying module 1508 includes: an operation determining module configured to determine, based on a set of operation identifiers in the second response, a set of operations corresponding to the set of operation identifiers; and a display module configured to performing the set of operations on the remaining part of content for display.

FIG. 16 illustrates a schematic block diagram of an example device 1600 for implementing embodiments of the present disclosure. The server 102 and the client 104 in FIG. 1 may be implemented by the device 1600. As shown in FIG. 16, the device 1600 comprises a central process unit (CPU) 1601, which can execute various suitable actions and processing based on the computer program instructions stored in the read-only memory (ROM) 1602 or computer program instructions loaded in the random-access memory (RAM) 1603 from the storage unit 1608. The RAM 1603 can also store all kinds of programs and data required by the operation of the device 1600. CPU 1601, ROM 1602 and RAM 1603 are connected to each other via a bus 1604. The input/output (I/O) interface 1605 is also connected to the bus 1604.

A plurality of components in the device 1600 is connected to the I/O interface 1605, including: an input unit 1606, such as keyboard, mouse and the like; an output unit 1607, e.g., various kinds of display and loudspeakers etc.; a storage unit 1608, such as disk and optical disk etc.; and a communication unit 1609, such as network card, modem, wireless transceiver and the like. The communication unit 1609 allows the device 1600 to exchange information/data with other devices via the computer network, such as Internet, and/or various telecommunication networks.

The above described procedure and processing, such as methods 200 and 300, and examples 400, 500 and 600, can be executed by the processing unit 1601. For example, in some embodiments, methods 200 and 300 and examples 400, 500 and 600 can be implemented as a computer software program tangibly included in the machine-readable medium, e.g., storage unit 1608. In some embodiments, the computer program can be partially or fully loaded and/or mounted to the apparatus 1600 via ROM 1602 and/or communication unit 1609. When the computer program is loaded to RAM 1603 and executed by the CPU 1601, one or more actions of the above described methods 200 and 300 and examples 400, 500 and 600 can be implemented.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

I/We claim:

1. A method for searching information, comprising:
in response to determining that request content in a search request from a client is associated with a predetermined category, obtaining a result identifier of an answer result for the search request;
generating, by a machine learning model, content of the answer result for the request content;
in response to obtaining a part of content of the answer result based on the result identifier, sending a first response comprising the part of content to the client to display the part of content of the answer result;
in response to receiving from a client an obtaining request for obtaining a remaining part of content of the answer result, obtaining the remaining part of content generated by the machine learning model; and
in response to obtaining the remaining part of content, sending a second response comprising the remaining part of content to the client for displaying the answer result comprising the part of content and the remaining part of content.

2. The method of claim 1, wherein obtaining the result identifier of the answer result for the search request comprising:
in response to determining that the request content of the search request from the client is associated with the predetermined category, sending the request content to the machine learning model; and
in response to the request content being processed by the machine learning model, obtaining the result identifier for identifying the answer result generated by the machine learning model.

3. The method of claim 1, further comprising:
sending the result identifier to a repository for storing content generated by the machine learning model; and
obtaining content of the answer result corresponding to the result identifier from the repository.

4. The method of claim 1, wherein obtaining the remaining part of content generated by the machine learning model comprises:
receiving the obtaining request for obtaining the remaining part of content of the answer result from the client;
obtaining the result identifier for the answer result by parsing the obtaining request; and
obtaining, based on the result identifier, the remaining part of content generated by the machine learning model.

5. The method of claim 4, wherein obtaining the result identifier for the answer result by parsing the obtaining request comprises:
reviewing parameters in the obtaining request; and
in response to determining that the parameters satisfy a predetermined requirement, parsing the obtaining request.

6. The method of claim 5, wherein the obtaining request comprises an encrypted result identifier, and in response to determining that the parameters satisfy the predetermined requirement, parsing the obtaining request comprises:
obtaining the result identifier by decrypting the encrypted result identifier.

7. The method of claim 6, wherein obtaining, based on the result identifier, the remaining part of content generated by the machine learning model comprises:
generating, based on the result identifier, a polling task for the answer result; and
obtaining, based on the polling task, the remaining part of content from a repository for storing content generated by the machine learning model.

8. The method of claim 7, wherein obtaining request also comprises the request content of the search request and the method further comprises:
in response to completion of the polling task, determining a set of recommended words for the request content; and
sending the set of recommended words to the client to be displayed simultaneously with the answer result.

9. The method of claim 1, wherein sending the second response comprising the remaining part of content to the client for displaying the answer result comprising the part of content and the remaining part of content comprises:
determining a streaming protocol for the answer result; and
providing, based on the streaming protocol, the second response comprising the remaining part of content to the client.

10. The method of claim 9, wherein providing, based on the streaming protocol, the second response comprising the remaining part of content to the client, comprises:
determining that the remaining part of content have been successfully obtained;
determining a set of predetermined operations to be executed for the remaining part of content; and
sending, based on the streaming protocol, the second response to the client, wherein the second response comprises an identifier indicating that the remaining part of content have been successfully obtained, a set of operation identifiers for the set of predetermined operations and the remaining part of content.

11. The method of claim 10, wherein the set of predetermined operations comprises at least one of: addition operation, replacement operation and deletion operation.

12. The method of claim 10, further comprising:
determining that the remaining part of content is not successfully obtained;
determining failure information indicating that the remaining part of content is not successfully obtained; and
sending, based on the streaming protocol, a third response to the client, wherein the third response comprises an identifier indicating that the remaining part of content is not successfully obtained and an identifier of the failure information.

13. The method of claim 1, further comprising:
receiving the search request from the client;
determining whether a predetermined keyword is present in the request content by reviewing the request content of the search request; and
in response to determining absence of the predetermined keyword in the request content, determining whether the search request is associated with the predetermined category;
in response to determining presence of the predetermined keyword in the request content, sending a prompt message for the search request to the client; and
wherein the answer result comprises at least one of: text data, image data; or video data.

14. The method of claim 1, further comprising:
determining, based on the request content, a set of search results for the request content; and
generating the first response based on the search result and the part of content.

15. A method for searching information, comprising:
sending a search request to a server, the search request comprising search content;
in response to receiving a first response for an answer result of the search content from the server, displaying content of the answer result, wherein the answer result is generated by a machine learning model on the basis of a determination that the search content is associated with a predetermined category;
in response to determining that the content of the answer result is a part of content of the answer result, sending to the server an obtaining request for obtaining a remaining part of content of the answer result; and
in response to receiving a second response comprising the remaining part of content of the answer result from the server, displaying the answer result comprising the part of content and the remaining part of content.

16. The method of claim 15, wherein the first response comprises a set of search results and displaying the content of the answer result comprises:
obtaining the set of search results and the answer result from the first response; and
displaying the answer result and the set of search results.

17. The method of claim 15, further comprising:
obtaining an integrity identifier for indicating whether content of the answer result is integral in the first response; and
determining, based on the integrity identifier, whether the content of the answer result is a part of content of the answer result.

18. The method of claim 15, further comprising:
obtaining a result identifier of the answer result from the first response; and
generating the obtaining request based on the result identifier; and
wherein generating the obtaining request based on the result identifier comprises:
generating an encrypted result identifier by encrypting the result identifier; and
generating, based on the encrypted result identifier, the obtaining result.

19. The method of claim 15, wherein displaying the answer result comprising the part of content and the remaining part of content comprises:
determining, based on a set of operation identifiers in the second response, a set of operations corresponding to the set of operation identifiers; and
performing the set of operations on the remaining part of content for display.

20. An electronic device, comprising:
at least one processor; and
a memory for storing at least one program which, when executed by the at least one processor, causes the at least one processor to implement the method comprising:
in response to determining that request content in a search request from a client is associated with a predetermined category, obtaining a result identifier of an answer result for the search request;
generating, by a machine learning model, content of the answer result for the request content;
in response to obtaining a part of content of the answer result based on the result identifier, sending a first response comprising the part of content to the client to display the part of content of the answer result;
in response to receiving from a client an obtaining request for obtaining a remaining part of content of the answer result, obtaining the remaining part of content generated by the machine learning model; and
in response to obtaining the remaining part of content, sending a second response comprising the remaining part of content to the client for displaying the answer result comprising the part of content and the remaining part of content.
